(19) United States
(12) Patent Application Publication
(10) Pub. No.: US 2017/0095827 A1
(43) Pub. Date: Apr. 6, 2017

(54) Universal Alignment Adapter

(71) Applicant: ADVANTECH GLOBAL, LTD, Tortola (VG)

(72) Inventors: David N. Monto, McKees Rocks, PA (US); Brian Arthur Bucci, Pittsburgh, PA (US); Shen-Chih Tung, Pittsburgh, PA (US); Nobuhiko Tamura, Murrysville, PA (US); Whitten E. Little, JR., Beaver, PA (US)

(21) Appl. No.: 15/333,743

(22) Filed: Oct. 25, 2016

Related U.S. Application Data
(63) Continuation-in-part of application No. 14/748,685, filed on Jun. 24, 2015.
Application No. 14/748,685 is a continuation-in-part of application No. 14/265,773, filed on Apr. 30, 2014, now Pat. No. 9,507,273.

(51) Int. Cl. B05B 15/04; H04N 5/225; H04N 7/18

(52) U.S. Cl. CPC B05B 15/0481; H04N 7/181; H04N 5/2256

(57) ABSTRACT

In a shadow mask tensioning method and apparatus, a shadow mask supported by a support frame is positioned between a shadow mask frame and a set of actuators with a portion of the shadow mask extending across a gap between the support frame and the shadow mask frame. Under the control of a programmed controller, the set of actuators is caused to simultaneously displace numerous, spaced locations of the portion of the shadow mask into the gap to align alignment apertures of the shadow mask to predetermined positons in fields of view of cameras positioned to observe the alignment apertures. The shadow mask is then affixed to the shadow mask frame.

### CROSS REFERENCE TO RELATED APPLICATIONS

This application is a continuation-in-part of U.S. patent application Ser. No. 14/265,773 filed Apr. 30, 2014 and U.S. patent application Ser. No. 14/748,685 filed on Jun. 24, 2015, the disclosures of both of which are incorporated herein by reference.

### BACKGROUND OF THE INVENTION

Field of the Invention

The present invention generally relates to the field of thin film electronic devices fabricated by additive manufacturing methods. In particular, the present invention is directed to a shadow mask used for patterning materials such as metals, oxides, and OLED compounds.

Description of Related Art

There is currently great interest in additive manufacturing methods for fabrication of thin film devices. Such methods would offer an alternative to established methods such as photolithography. Investigating alternatives to photolithography is of interest because photolithography requires significant facility floor space, requires numerous complex steps per patterned feature, and produces significant toxic chemical waste.

It is known in the art of additive manufacturing to employ the method of shadow masking. Shadow masking involves placing a substrate in close proximity or contact with a shadow mask that includes numerous formed apertures. Subsequently, material is deposited through the apertures, yielding the desired pattern on the substrate. Most often several shadow masks are required to produce a desired thin film device. Thus, it is necessary to precisely align the series of shadow masks with reference points on the substrate.

Typically, thin film devices require features to be accurately located within no more than a few micrometers of their specified location. Current alignment methods are capable of accurately placing the center of the shadow mask within less than 1 μm of its desired location. However, the shadow mask typically contains features over a significant area, hereinafter referred to as the “array.” Therefore, the size of the array must be controlled very precisely if the features of several masks are to be placed within their specified areas.

Because of the desired patterned feature sizes (typically >100 μm), the shadow mask is typically made of a thin metal foil less than 100 μm thick. Such a thin material does not have the structural integrity to be easily and safely handled on its own. Additionally, the shadow mask will be subject to elevated temperature during the deposition process and it is desired that the apertures of the array remain at constant locations during the thermal cycling. Therefore, tensioning the shadow mask and mounting the shadow mask to a rigid frame allows the shadow mask to be easily and safely handled while being robust to temperature changes.

Heretofore, heat was used to tension the shadow mask before it was attached to the frame. In this method, the frame is made of a low coefficient of thermal expansion alloy, such as invar. The frame and shadow mask are heated to a temperature where the array grows, via thermal expansion, to the proper size and an adhesive bonds the shadow mask to the frame. As the assembly cools, the shadow mask contracts more than the frame resulting in a tensioned shadow mask. This method of thermal tensioning does work but it has limitations and requires significant skill of the fabricator.

One limitation of thermal tensioning is that heat causes the shadow mask to expand proportionally in all directions. This method would be sufficient if all pre-mounted shadow masks are dimensionally accurate to the micrometer level. However, shadow masks often do not start with correct proportions. In an example, a shadow mask may require more stretch in a horizontal direction than in a vertical direction. The best course of action for mounting this shadow mask using thermal tensioning is to select a mounting temperature that splits the difference between the two desired dimensions. This introduces dimensional inaccuracies to the array of this shadow mask which could cause the shadow mask to become unusable. Therefore, the inability to adjust shadow mask dimensions independently is a limitation of thermal stretching.

When shadow masks are mounted via thermal tensioning, the selected mounting temperature should be higher than the maximum temperature realized at the shadow mask during deposition. When this is done the patterned features are generally observed to remain in their starting locations over the course of the thermal cycling of the deposition. According to observations, this starting location is the “cold” or room temperature dimension of the shadow mask. This differs from the mounting, “hot,” dimension of the shadow mask. When the shadow mask cools from the mounting temperature and becomes tensioned, the array changes in dimension. This process is somewhat repeatable in that shadow masks with the same aperture pattern tend to deform in the same fashion when transitioning from hot to cold states. However, achieving acceptable shadow mask mounting results requires collecting extensive data on the behavior of shadow masks and significant decision making from the fabricator. Further, transition from hot to cold can result in bowing of the array, a problem that cannot be directly addressed in the thermal tensioning process.

Including an elevated temperature within the mounting process also adds further complications. Introducing an environment of elevated and adjustable temperature greatly complicates the task of making the accurate micrometer scale measurements that are required for a precise shadow mask. Additionally, since it is continually desired to mount shadow masks at increasingly high temperatures, ease of handling and even operator safety become a concern.

Heretofore, tensioning of a shadow mask and mounting of the tension shadow mask to a rigid frame was performed manually. As would be appreciated by one of ordinary skill in the art, such manual process is time consuming and has the potential for the introduction of human error. Moreover, this prior art manual method is time consuming and may not be consistent when mounting and tensioning a number of different shadow masks to a like number of different shadow mask frames in a production environment where a used shadow mask that is coated with deposition material is replaced with a fresh, uncoated tensioned shadow mask.

### SUMMARY OF THE INVENTION

Various preferred and non-limiting examples will now be described as set forth in the following numbered clauses:

Clause 1: A shadow mask tensioning method comprises: (a) providing a shadow mask supported by a support frame; (b) following step (a), positioning the shadow mask supported by a support frame between a shadow mask frame and a set of actuators with a portion of the shadow mask extending across a gap between the support frame and the shadow mask frame; (c) following step (b), causing the set of actuators to simultaneously displace numerous, spaced locations of the portion of the shadow mask into the gap; and (d) following step (c), affixing the shadow mask to the shadow mask frame.

Clause 2: The method of clause 1, further including: a plurality of alignment apertures in the shadow mask; providing cameras to view the plurality of alignment apertures; and step (c) includes causing the set of actuators to displace the numerous, spaced locations of the portion of the shadow mask into the gap to align the plurality of alignment apertures to predetermined positons in fields of view of the cameras.

Clause 3: The method of clause 1 or 2, wherein step (c) occurs automatically under the control of a programmed controller.

Clause 4: The method of any one of clauses 1-3, wherein each camera is positioned with at least one alignment aperture in the field of view of the camera.

Clause 5: The method of any one of clauses 1-4, further including providing a light source for: projecting light onto a side of the shadow mask that faces the cameras; or passing light through the plurality of alignment apertures to the cameras.

Clause 6: The method of any one of clauses 1-5, further including: (e) following step (d), separating the shadow mask affixed to the shadow mask frame from the support frame.

Clause 7: The method of any one of clauses 1-6, wherein step (e) includes cutting the portion of the shadow mask extending across the gap.

Clause 8: The method of any one of clauses 1-7, wherein the gap and the portion of the shadow mask surround the shadow mask frame.

Clause 9: A shadow mask tensioning apparatus comprises: means for supporting a shadow mask that includes alignment apertures with a portion of the shadow mask in alignment with a gap; a plurality of cameras each of which is positioned to observe in a field of view of said camera at least one alignment aperture of the shadow mask; and means for individually displacing numerous, spaced locations of the portion of the shadow mask into the gap simultaneously based on the positions of the alignment apertures in the fields of view of the cameras.

Clause 10: The apparatus of clause 9, wherein the means for supporting includes a shadow mask frame surrounded in spaced relation by a support frame defining the gap.

Clause 11: The apparatus of clause 9 or 10, wherein the gap surrounds the shadow mask frame.

Clause 12: The apparatus of any one of clauses 9-11, further including a light source positioned to: project light on a side of the shadow mask that faces the cameras; or pass light through the alignment apertures to the cameras.

Clause 13: The apparatus of any one of clauses 9-12, wherein the plurality of cameras and the means for individually displacing are positioned on opposite sides of the shadow mask.

Clause 14: The apparatus of any one of clauses 9-13, wherein the alignment apertures are positioned to an inside or an outside of the shadow mask frame.

Clause 15: The apparatus of any one of clauses 9-14, wherein the means for individually displacing includes a plurality of actuators operating under the control of a programmed controller.

Clause 16: The apparatus of any one of clauses 9-15, wherein the controller is operative for controlling the plurality of actuators to move the at least one alignment aperture in the field of view of each camera to a predetermined positon in said field of view.

Clause 17: The apparatus of any one of clauses 9-16, wherein each actuator includes a piston or plunger that extends to displace one of the locations of the portion of the shadow mask.

Clause 18: The apparatus of any one of clauses 9-17, wherein each actuator is a servomotor.

Clause 19: The apparatus of any one of clauses 9-18, wherein the alignment apertures are positioned in an apertures section of the shadow mask.

### BRIEF DESCRIPTION OF THE DRAWINGS

FIG. 1 is a cross-sectional schematic view of an example apparatus for tensioning a shadow mask for thin film deposition, wherein the cross section is taken along lines I-I in FIG. 2;

FIG. 2 is a view taken along lines II-II in FIG. 1;

FIG. 3 is an isolated plan view of a cartridge assembly shown in FIG. 1 including a shadow mask and a support frame;

FIG. 4 is an isolated plan view of the camera array shown in FIG. 1;

FIG. 5 is an isolated view of a single camera, including an alignment aperture of the shadow mask of FIG. 1 in a field of view of the camera; and

FIG. 6 is an isolated view of the piston array assembly shown in FIG. 1, wherein the view is taken along lines VI-VI in FIG. 1.

### DESCRIPTION OF THE INVENTION

The following examples will be described with reference to the accompanying figures where like reference numbers correspond to like or functionally equivalent elements.

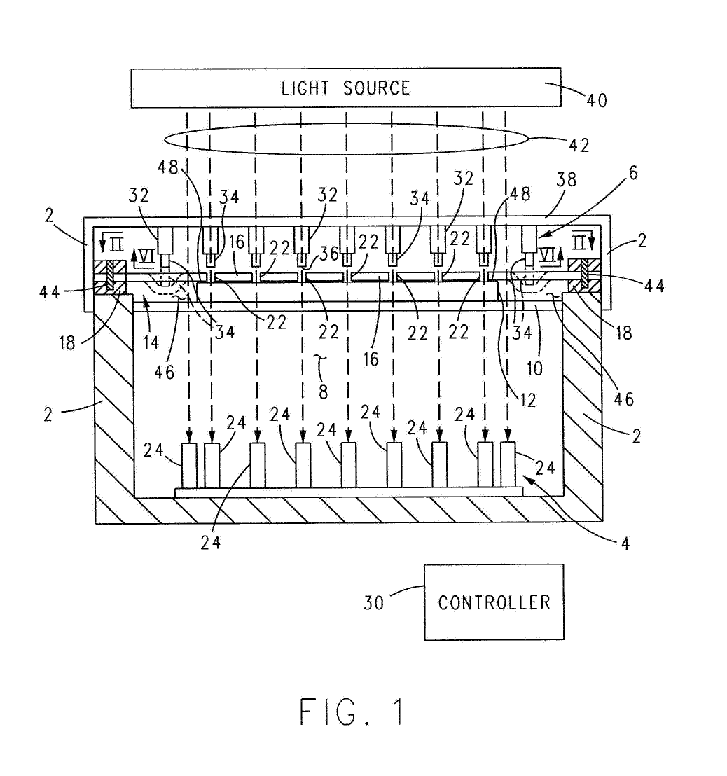

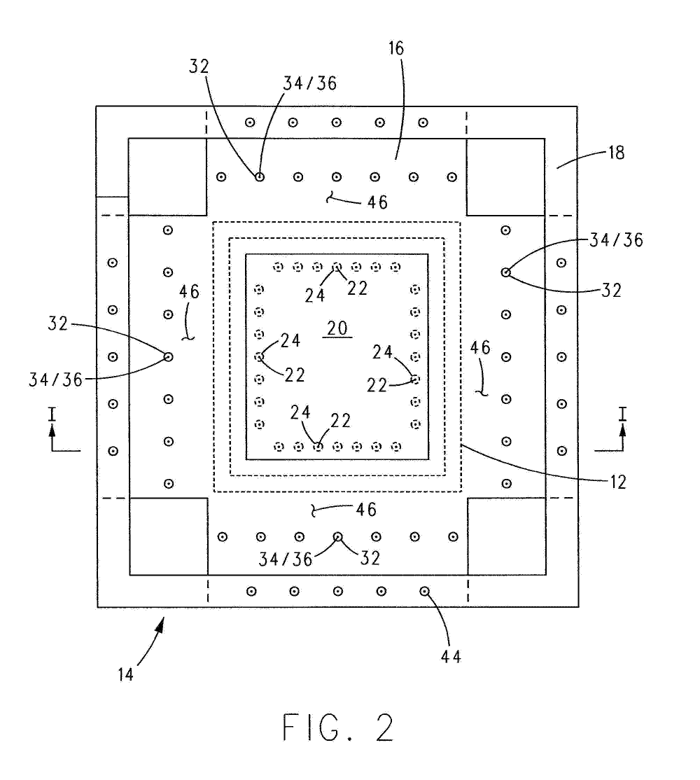

In an example, an apparatus for tensioning a shadow mask for thin film deposition is shown schematically in FIG. 1, which is a section taken along lines I-I in FIG. 2, and which is also shown in FIG. 2, which is a section taken along lines II-II in FIG. 1. FIGS. 1 and 2 are schematic drawings of an example shadow mask tensioning apparatus.

The example shadow mask tensioning apparatus includes a frame 2 that supports a camera array 4 and a piston array assembly 6 in spaced relation defining a gap 8 therebetween. Frame 2 supports a platform 10 which, in use, is configured to support a shadow mask frame 12 on a side of platform 10 opposite camera array 4. Frame 2 is also configured to support a replaceable cartridge assembly 14 comprised of a shadow mask 16 supported on its periphery by a support frame 18. In an example, the periphery shadow mask 16 can be affixed to support frame 18 in any suitable and/or desirable manner, e.g., fasteners 44.

As seen best in FIGS. 1 and 2, when replaceable cartridge assembly 14 is mounted on frame 2, shadow mask frame 12 is positioned under, and either spaced from or in contact with, the downward facing side of shadow mask 16 and a portion of shadow mask 16 extends across a gap 46 between shadow mask frame 12 and support frame 18.

Support frame 18 can be a metal frame to which shadow mask 16 is attached. Support frame 18 facilitates shadow mask 16 being easily handled and fixed in position when tensioned to a desired dimension.

As shown in FIG. 2, shadow mask 16 can be comprised of a square or rectangular, thin metal foil with an array of apertures 20 which can be formed in a central portion of shadow mask 16. While FIG. 2 shows a single aperture 20, it is to be appreciated that aperture 20 in FIG. 2 is representative of one or more apertures in a desired pattern.

Shadow mask 16 also includes a plurality of small alignment holes or apertures 22. In an example, each alignment aperture 22 can be a 50 un diameter hole. However, this is not to be construed in a limiting sense. As shown in FIG. 2, each alignment aperture 22 can be positioned about an interior of shadow mask frame 12 (shown in phantom in FIG. 2), for example, within the apertures 20 section of shadow mask 16. However, this is not to be construed in a limiting sense since it is envisioned that one or more alignment apertures can, also or alternatively, be positioned about an exterior of shadow mask frame 12.

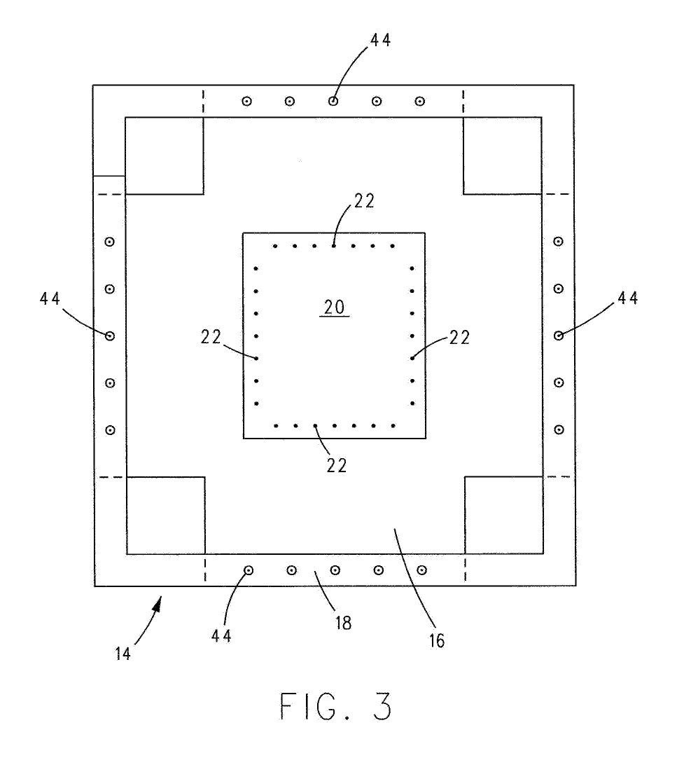

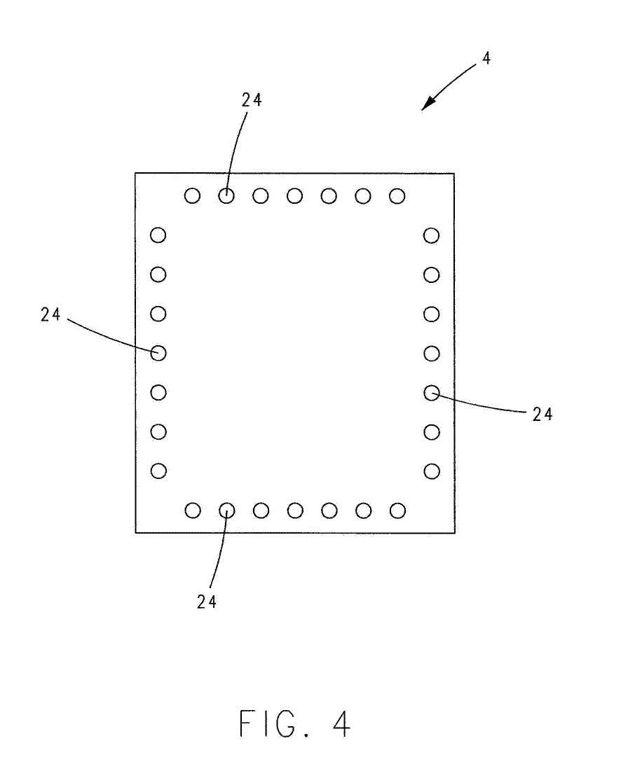

Camera array 4 includes a plurality of cameras 24 supported by frame 2. In an example, each camera 24 is positioned and oriented such that when shadow mask 16 and camera array 4 are in the position shown in FIG. 1, each camera 24 observes an area that includes at least one of the alignment apertures 22. Isolated views of cartridge assembly 14 (including shadow mask 16 supported by support frame 18) and camera array 4 including a plurality of cameras 24 are shown in FIGS. 3 and 4, respectively.

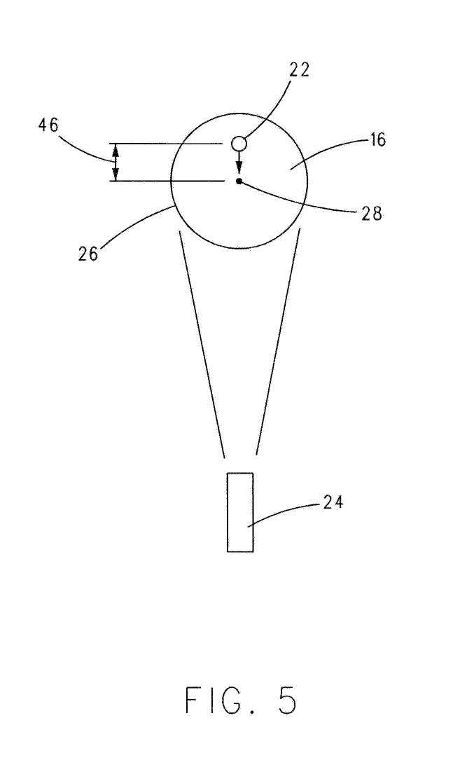

An isolated view of a single camera 24 of camera array 4 having a field of view 26 that observes an area in which at least a single alignment aperture 22 resides is shown in FIG. 5. FIG. 5 also shows an alignment mark 28 in the field of view 26 of camera 24. Alignment mark 28 does not exist physically but resides in a memory of controller 30 (FIG. 1) which is programmed and operative under the control of non-transitory computer readable program code (software) in a manner to tension shadow mask 16 (in a manner to be described hereinafter) to move alignment aperture 22 to the position represented by alignment mark 28 in FIG. 5. In other words, alignment mark 28 is representative of a predetermined, desired position in the field of view of camera 24 to which it is desired to move alignment aperture 22. One skilled in the art will recognize that, based on the position and orientation thereof, the field of view 26 of each camera 24 and the location of each alignment aperture 22 in said field of view 26 can be the same or different and that the position to which each alignment aperture 22 is moved in the field of view 26 of each camera 24, which position is represented by alignment mark 28 in FIG. 5, can also be different.

In an example, each field of view 26 of each camera 24 can observe an area having 1, or 2, or more alignment apertures 22 and an alignment mark 28 can be associated with a subset of said alignment apertures 22 in said field of view 26. In an example, there can be a one-to-one correspondence between each alignment aperture 22 and an alignment mark 28, e.g., as shown in FIG. 5. In another example, each alignment mark 28 can be associated with two or more alignment apertures 22, e.g., position the alignment mark 28 between the two or more alignment apertures 22. In yet another example, each alignment aperture 22 can be associated with two or more alignment marks 28, e.g., position the alignment aperture 22 between the two or more alignment marks 28. However, these examples are not to be construed in a limiting sense.

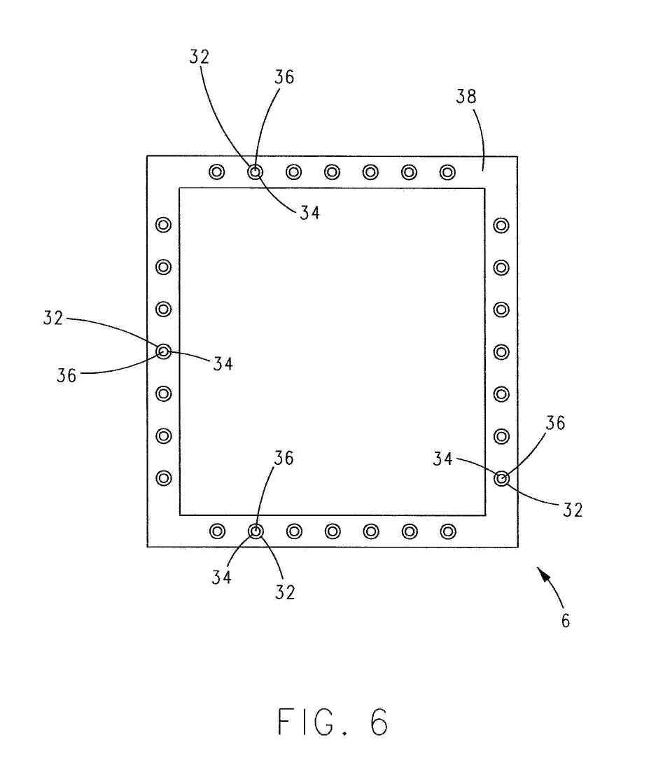

Referring now to FIGS. 1, 2, and 6, the latter of which is a view taken along lines VI-VI in Fig, 1, piston array assembly 6 includes a plurality actuators 32, each of which includes a piston or plunger 34. Operating under the control of controller 30, each actuator 32 can cause its piston 34 to move between a position where the distal end 36 of said piston 34 is spaced from shadow mask 16 (as shown by the solid lines of pistons 34 in FIG. 1) to a position in contact with a portion of shadow mask 16 (as shown by the dashed lines of pistons 34 in FIG. 1). In an example, each actuator can be a servomotor. In an example, controller 30 operating under the control of the non-transitory computer readable program code (software) can control the force applied by each actuator 32 individually on shadow mask 16, the amount of displacement of the portion of shadow mask 16 contacted by said actuator 32, or both.

Piston array assembly 6 includes a piston support frame 38 which is supported by frame 2 in a manner whereupon the distal ends 36 of pistons 34 of actuators 32 face the surface of shadow mask 16 opposite camera array 4.

Finally, in an example, depending on the amount of ambient light, an optional light source 40 can be positioned to a side of piston array assembly 6 opposite camera array 4. However, the positioning of optional light source 40 is not to be construed in a limiting sense since it is envisioned that optional light source 40 can alternatively be positioned to project light onto a side of shadow mask 16 that faces camera array 4. For the purpose of the following example, it will be assumed that optional light source 40 is present and is positioned as shown in FIG. 1.

In an example, camera array 4, platform 10, shadow mask frame 12, shadow mask 16, piston array assembly 6, and light source 40 are positioned such that a subset of alignment apertures 22 can pass light 42 from light source 40 to a corresponding subset of cameras 24. Herein, “subset” is a set consisting of elements of a given set that can be the same as the given set or smaller. Accordingly, the subset of alignment apertures 22 can include all or less than all of the alignment apertures 22. Similarly, the subset of cameras 24 can include all or less than all of the cameras 24.

In an example, there can be a one to one correspondence between a camera and a corresponding alignment aperture. However, this is not to be construed in a limiting sense since it is envisioned that any number of cameras 24 and any number of alignment apertures 22 can be utilized in the manner described hereinafter to tension shadow mask 16. Hence, for example, shadow mask 16 can include a large number of apertures, with only a portion of said apertures 22 being utilized to pass light 42 to a corresponding number of cameras 24 positioned to receive light passing through said apertures 22. Similarly, the number of cameras 24 is not to be construed in a limiting sense since it is envisioned that the number of cameras 24 used can be the same as, greater than, or equal to the number of alignment apertures 22 in shadow mask 16.

Having thus described the tensioning apparatus shown in FIG. 1, the operation of said tensioning apparatus will now be described.

Prior to use of the tensioning apparatus shown in FIG. 1, cartridge assembly 14 (FIG. 3) is assembled. Specifically, shadow mask 16 is attached to support frame 18 in any suitable and/or desirable manner. Prior to installing cartridge assembly 14 onto frame 2, shadow mask frame 12 is positioned on platform 10. Fiducial features (not shown) can be provided on platform 10, shadow mask frame 12, or both to facilitate desired positioning of shadow mask frame 12 on platform 10.

Next, cartridge assembly 14 is positioned on frame 2 with shadow mask 16 positioned between piston array assembly 6 and shadow mask frame 12. Fiducial features (not shown) can be provided on support frame 18, frame 2, or both to facilitate accurate positioning of cartridge assembly 14 on frame 2. In an example, the underside of shadow mask 16 can be in contact with the top side of shadow mask frame 12. However, this is not to be construed in a limiting sense.

In an example, piston array assembly 6 is fixed in position on frame 2 prior to mounting shadow mask frame 12 and cartridge assembly 14 on frame 2. However, this is not to be construed in a limiting sense since it is also envisioned that piston array assembly 6 can be mounted on frame 2 after installation of shadow mask frame 12, cartridge assembly 14, or both on frame 2.

Prior to tensioning of shadow mask 16, shadow mask 16 is held taut and planar by support frame 18 in the position shown by solid lines in FIG. 1.

When it is desired to tension shadow mask 16, light source 40 is activated to output light 42 through alignment apertures 22 and controller 30, operating under the control of the non-transitory computer readable program code, acquires the fields of view 26 of a subset of cameras 24. For each thus acquired field of view, controller. 30 determines the current position of at least one alignment aperture 22 in said field of view 26 and further determines a distance 46 (FIG. 5) and direction between the current position of said alignment aperture 22 and a desired position (represented in FIG. 5 by alignment mark 28) of said alignment aperture 22 in field of view 26. It is to be appreciated that alignment mark 28 in FIG. 5 is only for the purpose of illustration and is not actually present in the field of view 26 of camera 24. Rather, the position represented by alignment mark 28 (which is not present) in field of view 26 is programmed into a memory of controller 30 which is programmed to tension shadow mask 16 in the manner described next to move alignment aperture 22 in each field of view 26 to the desired position within said field of view 26, which desired position in the field of view 26 is represented by alignment mark 28 in FIG. 5. In an example, the position represented by an alignment mark 28 can be a predetermined pixel or array of pixels in the field of view 26 of a camera 24. Under the control of controller 30, shadow mask 16 can be tensioned to move the alignment aperture 22 into alignment with the predetermined pixel or array of pixels in the field of view 26.

In an example, once controller 30 has processed the images acquired from cameras 24 of the fields of view 26 of a subset of cameras 24 and has determined the distance and directions to move the alignment apertures 22 in said fields of view 26, controller 30 causes a subset (all or less than all) of actuators 32 to extend their respective pistons 34 until the distal ends 36 come into contact with the top surface of shadow mask 16. Thereafter, controller 30 controls each actuator 32 (e.g., a servomotor) to control the amount of force that the distal end 36 of the piston 34 of said actuator 32 applies to the portion of shadow mask 16 in contact with said distal end 36, or the amount that the portion of shadow mask 16 in contact with said distal end 36 displaces, or both. In response to the displacement of shadow mask 16 by the distal end 36 of each actuator 32 into the gap 46 between shadow mask frame 12 and support frame 18, tension is applied to shadow mask 16. By selectively controlling the amount of force, or displacement, or both applied to shadow mask 16 by the subset of actuators 32, the alignment apertures 22 can be moved to desired positions (e.g., move to the alignment marks 28) within the fields of view of cameras 24. Once the alignment apertures 22 have been moved to the desired positions (represented by alignment marks 28) within the fields of view of cameras 24, shadow mask 16 can be affixed to shadow mask frame 12 in any suitable and/or desirable manner, e.g., spot welding or adhesive 48.

In an example, controller 30 causes the subset (all or less than all) of actuators 32 to simultaneously displace multiple portions of shadow mask 16 in contact with the distal ends 36 of said actuators 32 at the same time. However, this is not to be construed in a limiting sense since it is envisioned that distal ends 36 of a first subset of actuators 32 can displace first portions of shadow mask 16 in contact therewith into a first part of gap 46 at a first time and the distal ends 36 of a second subset of actuators 32 can displace other portions of shadow mask 16 in contact therewith into a second part of gap 46 at a second, different time.

In the example shown in FIG. 5, the desired position is denoted by alignment mark 28 which, in an example, resides in a memory of controller 30 (e.g., as X×Y coordinate(s) of pixel(s) observed by camera 24) and which does not actually appear in the field of view 26. Because of alignment differences between cameras 24 of camera array 4, each aperture 22 can be at a different position in the field of view 26 of each camera 24. To account for this difference, the desired position (alignment mark 28) in each field of view 26 where it is desired to move the corresponding alignment aperture 22 can be programmed into controller 30. Once this programming is completed, because camera assembly 4 remains affixed to frame 2, this programming of the desired position (alignment mark 28) of each alignment aperture 22 can be utilized for tensioning any number of similar shadow mask 16 having the same arrangement/pattern of alignment apertures 22.

The foregoing example assumes that it would be necessary for a subset of actuators 32 to press down and apply a force to and, hence, displace portions of shadow mask 16 around (on all four sides of) shadow mask frame 12. However, this is not to be construed in a limiting sense since it is envisioned that a smaller subset of actuators 32 may only need to apply a force on corresponding portions of the shadow mask 16 on 1, 2 or 3 sides of shadow mask frame 12 in order to displace the portions of shadow mask 16 contacted by said smaller subset of actuators 32 to bring all of the alignment marks 22 in fields of view 26 of cameras 24 to the desired alignment positions (represented by alignment marks 28) within said fields of view.

Once all of the desired alignment apertures 22 have been positioned at the desired alignment positions (represented by alignment marks 28) within fields of view 26 of a subset of cameras 24, shadow mask 16 is permanently affixed to shadow mask frame 12 via, for example, without limitation, spot welding or adhesive. Once the securing of tensioned shadow mask 16 to shadow mask frame 12 is complete, controller 30 can cause actuators 32 to withdraw pistons 34 from contact with shadow mask 16. Thereafter, the portion of shadow mask 16 between shadow mask frame 12 and support frame 18 can be cut to separate shadow mask 16 affixed to shadow mask frame 12 from support frame 18.

The example thus described herein has several advantages over the prior art. First, since tension within the shadow mask is created by (simultaneous or individual) adjustment at numerous locations around the perimeter of the shadow mask, there is significant flexibility in the shape of the metal foil that comprises the shadow mask, and, hence, the shape of the array of apertures represented by aperture 20. Horizontal and vertical (X×Y) dimensions of the shadow mask and, hence, the array of apertures represented by aperture 20 can be adjusted separately.

Moreover, the use of camera array 4 and controller 30 in combination with alignment apertures 22 in shadow mask 16 facilitates accurate and automated tensioning of shadow mask 16. Furthermore, frame 2, including platform 10, enables tensioning of a number of similar shadow masks 16 to a like number of similar shadow mask frames 12 in a quick and efficient manner. For example, once a first shadow mask 16 has been tensioned and secured to a first shadow mask frame 12, said first shadow mask 16 and first shadow mask frame 12 can be removed from frame 2 and a second, similar shadow mask 16 can be tensioned and secured to a second, similar shadow mask frame 12 on frame 2 in the manner described above. This process can be repeated for any number of similar shadow masks and shadow mask frames.

As can be seen, disclosed herein a measurement system and method that can be used for rapidly and accurately aligning locations 22 on a work piece 16 to predetermined positions 28. The measurement system and method can be used for rapidly and accurately aligning any number of like or similar work pieces. The measurement system and method can employ a camera at each location 22 to facilitate aligning said locations 22 to said predetermined positions 28. Determination of how to adjust each work piece to align all of the locations 22 to the predetermined positions 28 can occur simultaneously or near simultaneously, e.g., within 10-100 milliseconds, since the cameras are stationary and do not need to move between locations 22 in operation of the system.

Total measurement time can be reduced over systems that use/move one or more cameras between multiple locations by a factor (F) of at least: F=# of measured locations÷time to take measurement of all locations.

Finally, because the cameras are rigidly attached to the frame and, hence, are stationary, repeatability error and angular errors of the cameras are avoided.

The foregoing example has been described with reference to the accompanying figures. Modifications and alterations will occur to others upon reading and understanding the foregoing example. Accordingly, the foregoing example is not to be construed as limiting the disclosure.

The invention claimed is

1. A shadow mask tensioning method comprising:
(a) providing a shadow mask supported by a support frame;
(b) following step (a), positioning the shadow mask supported by a support frame between a shadow mask frame and a set of actuators with a portion of the shadow mask extending across a gap between the support frame and the shadow mask frame;
(c) following step (b), causing the set of actuators to simultaneously displace numerous, spaced locations of the portion of the shadow mask into the gap; and
(d) following step (c), affixing the shadow mask to the shadow mask frame.

2. The method of claim 1, further including:
a plurality of alignment apertures in the shadow mask;
providing cameras to view the plurality of alignment apertures; and
step (c) includes causing the set of actuators to displace the numerous, spaced locations of the portion of the shadow mask into the gap to align the plurality of alignment apertures to predetermined positons in fields of view, of the cameras.

3. The method of claim 2, wherein step (c) occurs automatically under the control of a programmed controller.

4. The method of claim 2, wherein each camera is positioned with at least one alignment aperture in the field of view of the camera.

5. The method of claim 2, further including providing a light source for:
projecting light onto a side of the shadow mask that faces the cameras; or
passing light through the plurality of alignment apertures to the cameras.

6. The method of claim 1, further including:
(e) following step (d), separating the shadow mask affixed to the shadow mask frame from the support frame.

7. The method of claim 6, wherein step (e) includes cutting the portion of the shadow mask extending across the gap.

8. The method of claim 1, wherein the gap and the portion of the shadow mask surround the shadow mask frame.

9. A shadow mask tensioning apparatus comprising:
means for supporting a shadow mask that includes alignment apertures with a portion of the shadow mask in alignment with a gap;
a plurality of cameras each of which is positioned to observe in a field of view of said camera at least one alignment aperture of the shadow mask; and
means for individually displacing numerous, spaced locations of the portion of the shadow mask into the gap simultaneously based on the positions of the alignment apertures in the fields of view of the cameras.

10. The apparatus of claim 9, wherein the means for supporting includes a shadow mask frame surrounded in spaced relation by a support frame defining the gap.

11. The apparatus of claim 10, wherein the gap surrounds the shadow mask frame.

12. The apparatus of claim 9, further including a light source positioned to:
project light on a side of the shadow mask that faces the cameras; or
pass light through the alignment apertures to the cameras.

13. The apparatus of claim 9, wherein the plurality of cameras and the means for individually displacing are positioned on opposite sides of the shadow mask.

14. The apparatus of claim 9, wherein the alignment apertures are positioned to an inside or an outside of the shadow mask frame.

15. The apparatus of claim 9, wherein the means for individually displacing includes a plurality of actuators operating under the control of a programmed controller.

16. The apparatus of claim 15, wherein the controller is operative for controlling the plurality of actuators to move the at least one alignment aperture in the field of view of each camera to a predetermined positon in said field of view.

17. The apparatus of claim 15, wherein each actuator includes a piston or plunger that extends to displace one of the locations of the portion of the shadow mask.

18. The apparatus of claim 15, wherein each actuator is a servomotor.

19. The apparatus of, claim 9, wherein the alignment apertures are positioned in an apertures section of the shadow mask.
